(19) United States
(12) Patent Application Publication
(10) Pub. No.: US 2025/0055610 A1
(43) Pub. Date: Feb. 13, 2025

(54) METHOD FOR CONFIGURING RESOURCES, TERMINAL, AND NETWORK DEVICE

(71) Applicant: GUANGDONG OPPO MOBILE TELECOMMUNICATIONS CORP., LTD., Dongguan (CN)

(72) Inventors: Shichang ZHANG, Dongguan (CN); Zhenshan ZHAO, Dongguan (CN); Teng MA, Dongguan (CN)

(21) Appl. No.: 18/927,085

(22) Filed: Oct. 25, 2024

Related U.S. Application Data
(63) Continuation of application No. PCT/CN2022/106107, filed on Jul. 15, 2022.

(51) Int. Cl. H04L 5/00; H04W 72/25

(52) U.S. Cl. CPC H04L 5/0005; H04W 72/25

(57) ABSTRACT

The present application provides a method for configuring resources. The method includes: receiving configuration signaling, wherein the configuration signaling includes at least one of a configuration of frequency domain resources or a configuration of time domain resources of a sidelink positioning reference signal (SL PRS) resource pool. The SL supports transmission of a positioning reference signal (PRS).

### CROSS-REFERENCE TO RELATED APPLICATION

This application is a continuation application of international application No. PCT/CN2022/106107, filed on Jul. 15, 2022, the disclosure of which is incorporated herein by reference in its entirety.

### TECHNICAL FIELD

The present disclosure relates to the field of sidelink (SL) communications, and in particular, relates to a method for configuring resources, a terminal and a network device.

### BACKGROUND

Currently, in the case that a sidelink (SL) supports transmission of a positioning reference signal (PRS), there is no clear solution on how to determine or indicate a resource (a resource pool) for PRS transmission.

### SUMMARY

Embodiments of the present disclosure provide a method for configuring resources, a terminal and a network device.

According to some embodiments of the present disclosure, a method for configuring resources is provided. The method includes: receiving configuration signaling, wherein the configuration signaling includes at least one of a configuration of frequency domain resources or a configuration of time domain resources of an SL PRS resource pool.

According to some embodiments of the present disclosure, a terminal is provided. The terminal includes: a processor; a transceiver connected to the processor; and a memory configured to store one or more executable programs. The processor, when loading and running the one or more executable programs, is caused to perform: receiving configuration signaling, wherein the configuration signaling includes at least one of a configuration of frequency domain resources or a configuration of time domain resources of an SL PRS resource pool.

According to some embodiments of the present disclosure, a network device is provided. The network device includes: a processor; a transceiver connected to the processor; and a memory configured to store one or more executable programs. The processor, when loading and running the one or more executable programs, is caused to perform: transmitting configuration signaling, wherein the configuration signaling includes at least one of a configuration of frequency domain resources or a configuration of time domain resources of an SL PRS resource pool.

### BRIEF DESCRIPTION OF DRAWINGS

For clearer descriptions of the technical solutions in the embodiments of the present disclosure, the accompanying drawings required for describing the embodiments are briefly introduced hereinafter. Apparently, the accompanying drawings in the following description show merely some embodiments of the present disclosure, and those of ordinary skill in the art may still derive other accompanying drawings from these accompanying drawings without creative efforts.

FIG. 1 is a schematic diagram of a multiplexing mode of a physical sidelink control channel (PSCCH) and a physical sidelink shared channel (PSSCH) in the related art;

FIG. 2 is a schematic structural diagram of frequency domain resources in a resource pool in the related art;

FIG. 3 is a schematic structural diagram of slots in a new radio (NR) system in the related art;

FIG. 4 is a schematic structural diagram of slots in SL transmission in the related art;

FIG. 5 is a schematic diagram of a time domain resource determination mode in the related art;

FIG. 6 is a schematic flowchart of a method for configuring resources according to some embodiments of the present disclosure;

FIG. 7 is a schematic flowchart of a method for configuring resources according to some embodiments of the present disclosure;

FIG. 8 is a schematic structural diagram of frequency domain resources according to some embodiments of the present disclosure;

FIG. 9 is a schematic structural diagram of frequency domain resources according to some embodiments of the present disclosure;

FIG. 10 is a schematic structural diagram of frequency domain resources according to some embodiments of the present disclosure;

FIG. 11 is a schematic structural diagram of frequency domain resources according to some embodiments of the present disclosure;

FIG. 12 is a schematic flowchart of a method for configuring resources according to some embodiments of the present disclosure;

FIG. 13 is a schematic flowchart of a method for configuring resources according to some embodiments of the present disclosure;

FIG. 14 is a schematic flowchart of a method for configuring resources according to some embodiments of the present disclosure;

FIG. 15 is a schematic structural diagram of frequency domain resources according to some embodiments of the present disclosure;

FIG. 16 is a schematic flowchart of a method for configuring resources according to some embodiments of the present disclosure;

FIG. 17 is a structural block diagram of an apparatus for configuring resources according to some embodiments of the present disclosure;

FIG. 18 is a structural block diagram of an apparatus for configuring resources according to some embodiments of the present disclosure; and

FIG. 19 is a schematic structural diagram of a communication device for configuring resources according to some embodiments of the present disclosure.

### DETAILED DESCRIPTION

For clearer descriptions of the objects, technical solutions, and advantages of the present disclosure, the embodiments of the present disclosure are further described in detail hereinafter with reference to the accompanying drawings. Embodiments are described in detail herein, examples of which are illustrated in the accompanying drawings. In the case that the following description is made with reference to the accompanying drawings, unless indicated otherwise, same numbers in different accompanying drawings represent same or similar elements. Implementations described in the following embodiments do not represent all implementations consistent with the present disclosure. Instead, they are merely examples of apparatuses and methods consistent with some aspects of the present disclosure as recited in the appended claims.

The terms used in the present disclosure are intended only to describe particular embodiments and are not intended to limit the present disclosure. As used in the present disclosure and the appended claims, the singular forms of “a/an” and “the” are also intended to include plural forms, unless otherwise clearly specified in the context. It is understandable that the term “and/or” used herein refers to any and all possible combinations of one or more of relevant listed items.

It is understandable that although the terms such as first, second, and third may be used in the present disclosure to describe various information, the information should not be limited to these terms. These terms are only used to distinguish the same type of information from each other. For example, without departing from the scope of the present disclosure, first information may be referred to as second information, and similarly, the second information may be referred to as the first information. Depending on the context, the word “if” as used herein may be interpreted as “when” or “in the case that” or “in response to determining.”

First, relevant technical background of the embodiments of the present disclosure is introduced.

### Slot Structure for NR-Vehicle to X (V2X):

An NR-V2X system has a lower latency than a long-term evolution (LTE)-V2X system. Therefore, a multiplexing mode of a PSCCH and a PSSCH of the NR-V2X system is redesigned compared with the LTE-V2X system. In the LTE-V2X system, the PSCCH and the PSSCH are in a frequency-division multiplexing (FDM) mode. A terminal detects the PSSCH after the PSCCH is received, which may increase the latency. In the NR-V2X system, the PSCCH and the PSSCH adopt a multiplexing mode as illustrated in FIG. 1.

In NR-V2X, in addition to an automatic gain control (AGC) symbol, the PSCCH occupies two or three orthogonal frequency-division multiplexing (OFDM) symbols. Moreover, time domain positions thereof start from the 2^{nd} one of time domain symbols available for SL transmission in the slot (the 1^{st} time domain symbol is the AGC symbol), and the number of physical resource blocks (PRBs) occupied in frequency domain is configurable.

### Determination of NR-V2X Frequency Domain Resources:

Similar to LTE-V2X, frequency domain resources in an NR-V2X resource pool are continuous, and the frequency domain resources are assigned in the granularity of subchannels. The number of PRBs included in one subchannel is {10, 12, 15, 20, 50, 75, 100}. The minimum subchannel size is 10 PRBs, which is much larger than the minimum subchannel size, 4 PRBs in LTE-V2X. This is mainly because frequency domain resources of the PSCCH in NR-V2X are located in the 1st subchannel of the PSSCH associated therewith, a size of the frequency domain resources of the PSCCH is less than or equal to a size of one subchannel of the PSSCH, while time domain resources of the PSCCH occupy two or three OFDM symbols, in the case that the size of the subchannel is relatively small, available resources for the PSCCH are fewer, a bit rate is increased, and detection performance of the PSCCH is degraded. In NR-V2X, the size of the subchannel of the PSSCH and the size of the frequency domain resources of the PSCCH are configured independently, but it is ensured that the size of the frequency domain resources of the PSCCH is less than or equal to the size of the subchannel of the PSSCH. The following configuration parameters in configuration information of the NR-V2X resource pool are used to determine frequency domain resources of PSCCH and PSSCH resource pools:
a subchannel size (sl-SubchannelSize): indicating the number of contiguous PRBs included in one subchannel in a resource pool, with a value range of {10, 12, 15, 20, 50, 75, 100} PRBs;
the number of subchannels (sl-NumSubchannel): indicating the number of subchannels included in the resource pool;
a start RB index of the subchannel (sl-StartRB-Subchannel): indicating a start PRB index of the 1st subchannel in the resource pool;
the number of PRBs (sl-RB-Number): indicating the number of contiguous PRBs included in the resource pool; and
a PSCCH frequency domain resource indicator (sl-FreqResourcePSCCH): indicates a size of frequency domain resources of the PSCCH, with a value range of {10, 12, 15, 20, 25} PRBs.

In the case that a UE determines a resource pool for PSSCH transmission or PSSCH reception, frequency domain resources included in the resource pool are sl-NumSubchannel contiguous subchannels starting from the PRB indicated by sl-StartRB-Subchannel. In the case that the number of PRBs included in the sl-NumSubchannel contiguous subchannels is less than the number of PRBs indicated by sl-RB-Number, remaining PRBs cannot be used for PSSCH transmission or reception.

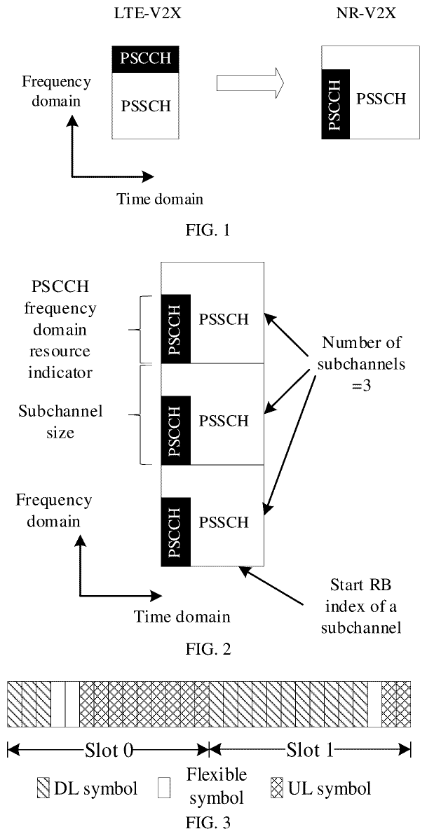

In NR-V2X, frequency domain start positions of the 1st subchannels of the PSCCH and the PSSCH associated therewith are aligned. Therefore, the start position of each PSSCH subchannel is a possible frequency domain start position of the PSCCH, and frequency domain ranges of the PSCCH and PSSCH resource pools can be determined based on the above parameters, as illustrated in FIG. 2.

### Determination of NR-V2X Time Domain Resources (Slots):

In NR-V2X, PSCCH/PSSCH transmission is slot-based. That is, only one PSCCH/PSSCH can be transmitted in one slot, transmission of a plurality of PSCCHs/PSSCHs in a time-division multiplexing (TDM) mode within one slot is not supported, and a PSCCH/PSSCH between different users may be multiplexed in one slot in an FDM mode. Time domain resources of the PSSCH in NR-V2X are based on the granularity of slots. However, unlike LTE-V2X where the PSSCH occupies all time domain symbols in one subframe, the PSSCH in NR-V2X may occupy part of the symbols in one slot. This is mainly because, in the LTE system, uplink (UL) or downlink (DL) transmission is based on granularity of subframes. Therefore, SL transmission is also based on granularity of subframes, but special subframes in a time division duplexing (TDD) system are not used for SL transmission. In the NR system, a flexible slot structure is adopted. That is, one slot includes both a UL symbol and a DL symbol, such that more flexible scheduling can be achieved and the latency can be reduced. A typical subframe of a NR system is illustrated in FIG. 3. A slot may include a DL symbol, a UL symbol, and a flexible symbol. The DL symbol is located at a start position of the slot, the UL symbol is located at an end position of the slot, and the flexible symbol is located between the DL symbol and the UL symbol. The number of various symbols in each slot is configurable.

As described above, an SL transmission system may share carriers with a cellular system. In this case, only uplink transmission resources of the cellular system can be used in SL transmission. With respect to NR-V2X, in the case that SL transmission is still required to occupy all time domain symbols in one slot, slots with all UL symbols for SL transmission need to be configured in a network, which may exert a great impact on UL and DL data transmission of the NR system and degrade the performance of the system. Therefore, in NR-V2X, part of the time domain symbols in a slot are supported for SL transmission. That is, part of the UL symbols in one slot are used for SL transmission. In addition, SL transmission includes AGC symbols and guard period (GP) symbols. In consideration of this, if there is a small number of UL symbols available for SL transmission and the AGC symbols and the GP symbols are excluded, fewer symbols available for valid data transmission are left, thereby resulting in very low resource utilization. Therefore, in NR-V2X, SL transmission occupies at least seven time domain symbols (including the GP symbols). In the case that the SL transmission system uses a dedicated carrier, there is no problem of sharing transmission resources with other systems. Then, all symbols in the slot may be configured for SL transmission.

In NR-V2X, a start point and a length of time domain symbols for SL transmission in one slot are configured by parameters of a start symbol position (sl-StartSymbol) and the number of symbols (sl-LengthSymbols), the last symbol in the time domain symbols for SL transmission is used as a GP, and remaining time domain symbols are used in the PSSCH and the PSCCH. However, in the case that a physical sidelink feedback channel (PSFCH) for transmitting resources are configured in one slot, the PSSCH and the PSCCH cannot occupy a time domain symbol for PSFCH transmission and AGC and GP symbols before this symbol.

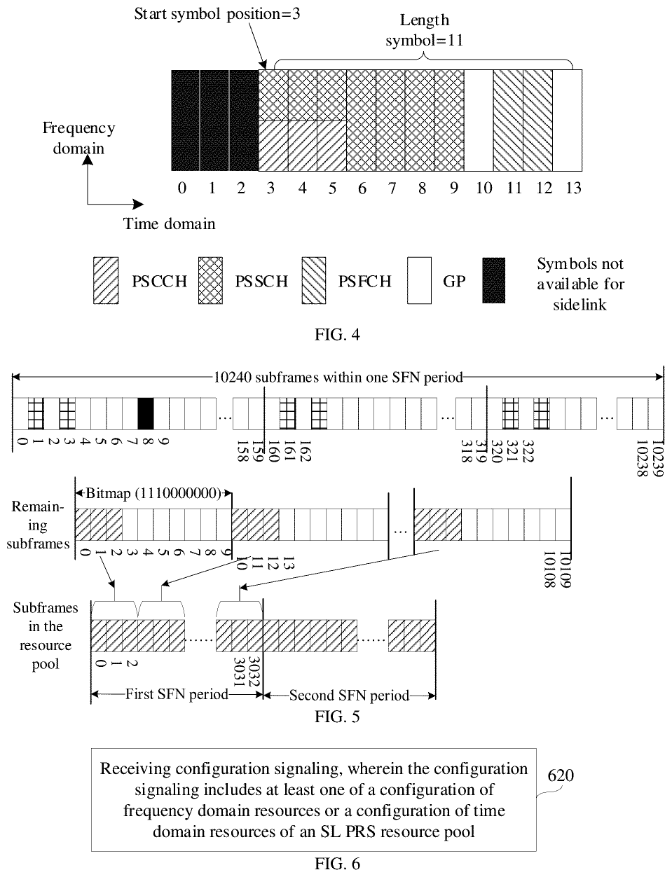

As illustrated in FIG. 4, the network configures the start symbol position to 3 and the number of symbols to 11. That is, 11 time domain symbols in one slot starting from a symbol index 3 is used for SL transmission. Symbol 3 is generally used as an AGC symbol, symbol 13 is used as a GP, remaining symbols are used for PSCCH and PSSCH transmission, and the PSCCH occupies two time domain symbols. However, because data on the AGC symbol is a duplicate of data on a second SL symbol, a first SL symbol also includes PSCCH data.

In the NR-V2X system, the time domain resources in the resource pool are indicated by a bitmap. In consideration of the flexible slot structure in the NR system, a length of the bitmap is also extended. A supported range of the length of the bitmap is [10:160]. A manner of determining a slot position belonging to the resource pool within a system frame number (SFN) or direct frame number (DFN) period using a bitmap is roughly the same as that in LTE-V2X, with the following two differences.

The total number of slots included in one period is 10240×2^{μ}, wherein the parameter μ is related to a subcarrier spacing.

In the case that at least one of time domain symbols A, A+1, A+2, . . . , A+B−1 included in one slot is not configured as a UL symbol by TDD-UL-DL-ConfigCommon signaling of the network, the slot cannot be used for SL transmission. A and B respectively represent sl-StartSymbol and sl-LengthSymbols.

For example, the following processes are included (the SFN period is taken as an example for illustration).

In process 1, slots not belonging to a resource pool are removed within an SFN period, including synchronization slots and slots unavailable for SL transmission. The remaining slots are represented as a set of remaining slots, and the remaining slots are renumbered as

$$( {l}_{0} , {l}_{1} , … , {l}_{( 10240 \times {2}^{μ} - {N}_{S \_ SSB} - {N}_{nonSL} - 1 )} ) .$$

N_{S_SSB} represents the number of synchronization slots within one SFN period; and the synchronization slots are determined based on synchronization-related configuration parameters and are related to a period of transmission of synchronization signal blocks (SSBs) and the number of SSB transmission resources configured within the period.

N_{nonSL} represents the number of slots not matching the start points and number configurations of the UL symbols within one SFN period: in the case that at least one of time domain symbols A, A+1, A+2, . . . , A+B−1 included in one slot is not semi-statically configured as a UL symbol, the slot cannot be used for SL transmission. A and B respectively represent sl-StartSymbol and sl-LengthSymbols.

In process 2, the number of reserved slots and corresponding time domain positions are determined.

In the case that the number of slots in the set of the remaining slots cannot be evenly divided by the length of the bitmap, the number of reserved slots and the corresponding time domain positions need to be determined. For example, in the case that one slot lᵣ (0≤r<10240×2^{μ}−N_{S_SSB}−N_{nonSL}) meets the following condition, the slot is the reserved slot,

$$r = ⌊ \frac{m \cdot ( 10240 \times {2}^{μ} - {N}_{S \_ SSB} - {N}_{nonSL} )}{{N}_{reserved}} ⌋$$

wherein

N_{reserved}=(10240×2^{μ}−N_{S_SSB}−N_{nonSL}) mod L_{bitmap}, N_{reserved} represents the number of reserved slots, L_{bitmap} represents the length of the bitmap, and m=0, . . . , N_{reserved}−1.

In process 3, the reserved slots are removed from the set of remaining slots, and the set of remaining slots is represented as a logical slot set, wherein all the slots in the slot set are slots available for the resource pool, and slots in the logical slot set are renumbered as

$$( {t}_{0}^{SL} , {t}_{1}^{SL} , … , {t}_{{T}_{m ax} - 1}^{SL} ) ,$$

$$wherein$$

$${T}_{ma x} = 10240 \times {2}^{μ} - {N}_{S\_SSB} - {N}_{nonSL} - {N}_{reserved} .$$

In process 4, slots in the logical slot set that belong to the resource pool are determined based on a bitmap.

The bitmap in configuration information of the resource pool is (b₀, b₁, . . . , b_{L}_{_{bitmap}}₋₁). With respect to a slot tₖ^{SL} (0≤k<(10240×2^{μ}−N_{S_SSB}−N_{nonSL}−N_{reserved})) in the logical slot set, in the case that b_{k′}=1 is satisfied, the slot is a slot belonging to the resource pool, wherein k′=k mod L_{bitmap}.

In process 5, the slots belonging to the resource pool determined in process 4 are renumbered as t′ᵢ^{SL}, i∈{0, 1, . . . , T′ₘₐₓ−1}, wherein T′ₘₐₓ represents the number of slots included in the resource pool.

As illustrated in FIG. 5, one SFN period (DFN period) includes 10240 subframes, a period of a synchronization signal is 160 ms, and one synchronization period includes 2 synchronization subframes. Therefore, there are 128 synchronization subframes within one SFN period. The length of the bitmap indicating the time domain resources of the resource pool is 10 bits. Therefore, 2 reversed subframes are required, and the number of remaining subframes is (10240−128−2=10110), which is evenly divided by the length 10 of the bitmap. The remaining subframes are renumbered as 0, 1, 2, . . . , 10109. Each of the first 3 bits of the bitmap is 1, and each of the remaining 7 bits is 0. That is, in the remaining subframes, the first 3 subframes out of every 10 subframes belong to the resource pool, and the remaining subframes do not belong to the resource pool. The bitmap is required to be repeated 1011 times in the remaining subframes to indicate whether all the subframes belong to the resource pool, and each bitmap period includes 3 subframes. Therefore, a total of 3033 subframes belong to the resource pool within one SFN period.

### SL-Based Positioning:

SL-based positioning is one of the enhancement solutions of the R18 positioning technology. In this topic, scenarios and requirements for supporting NR positioning application cases in-coverage, partial-coverage, and out-of-coverage of a cellular network are considered, and positioning requirements for V2X application cases, public safety application cases, commercial application cases, and industrial Internet of things (IIOT) application cases are considered. Further, supports for the following functions are considered:
absolute positioning, ranging/direction measurement, and relative positioning;
investigating a positioning method based on the combination of SL measurement results and user-equipment UTRAN (Uu) interface measurement results;
investigating SL positioning reference signals, including signal design, physical layer control signaling, resource assignment, physical layer measurement results, related physical layer processes, or the like; and
investigating a positioning system architecture and signaling processes, such as configuration and measurement reporting.

The technical solutions according to some embodiments of the present disclosure are applicable to various communication systems, for example, a global system of mobile communication (GSM), a code-division multiple access (CDMA) system, a wideband code division multiple access (WCDMA) system, a general packet radio service (GPRS) system, a long-term evolution (LTE) system, an LTE frequency-division duplex (FDD) system, an LTE time-division duplex (TDD) system, an advanced long-term evolution (LTE-A) system, a universal mobile telecommunication system (UMTS), a worldwide interoperability for microwave access (WiMAX) communication system, a 5^{th} Generation (5G) mobile communication system, a new radio (NR) system, an evolution system of the NR system, an LTE-based access to unlicensed spectrum (LTE-U) system, a NR-based access to unlicensed spectrum (NR-U) system, a non-terrestrial networks (NTN) system, a wireless local area networks (WLAN) system, a wireless fidelity (Wi-Fi) system, a cellular Internet of things (IoT) systems, and a cellular passive IoT system, are also applicable to subsequent evolution systems of a 5G NR system, and are further applicable to 6G and subsequent evolution systems. In some embodiments of the present disclosure, “NR” may also be referred to as a 5G NR system or 5G system. The 5G mobile communication system may include at least one of a non-standalone (NSA) network or a standalone (SA) network.

The technical solutions according to some embodiments of the present disclosure are further applicable to machine type communication (MTC), long-term evolution-machine (LTE-M), a device to device (D2D) network, a machine to machine (M2M) network, an IoT network, or other networks. The IoT network may include, for example, Internet of Vehicles (IoV). Communication manners in the IoV system are collectively referred to as vehicle to other devices (vehicle to X, V2X, wherein X represents anything). For example, the V2X includes: vehicle to vehicle (V2V) communication, vehicle to infrastructure (V2I) communication, vehicle to pedestrian (V2P) communication, vehicle to network (V2N) communication, and the like.

In some embodiments of the present disclosure, the method is applicable to a terminal. The terminal may also be referred to as a user equipment (UE), an access terminal, a user unit, a user station, a mobile station, a mobile platform, a remote station, a remote terminal, a mobile device, a user terminal, a terminal, a wireless communication device, a user agent, or a user apparatus. The terminal includes, but is not limited to, a handheld device, a wearable device, a vehicle-mounted device, an IoT device, or the like, such as a mobile phone, a tablet computer, an e-book reader, a laptop computer, a desktop computer, a television, a game console, a mobile Internet device (MID), an augmented reality (AR) terminal, a virtual reality (VR) terminal, a mixed reality (MR) terminal, a wearable device, a gamepad, an electronic tag, a controller, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, a wireless terminal in remote medical surgery, a cellular telephone, a cordless telephone, a Session Initiation Protocol (SIP) telephone, a wireless local loop (WLL) station, a personal digital assistant (PDA), a set top box (STB), a customer premise equipment (CPE), or the like.

In some embodiments of the present disclosure, the method is applicable to a network device. The network device includes, but is not limited to, an evolved Node B (eNB), a radio network controller (RNC), a Node B (NB), a base station controller (BSC), a base transceiver station (BTS), a home base station (e.g., home evolved NodeB, or home Node B (HNB)), a baseband unit (BBU), an access point (AP) in a Wi-Fi system, a wireless relay node, a wireless backhaul node, a transmission point (TP), a transmission and reception point (TRP), or the like, which may be a next generation node B (gNB) or transmission point (TRP or TP) in a 5G system or one antenna panel or a group (including a plurality of antenna panels) of antenna panels of a base station in the 5G system, or, may be a network node that constitutes a gNB or a transmission point, such as a baseband unit (BBU) or a distributed unit (DU), or a base station in a 6G communication system.

FIG. 6 is a schematic flowchart of a method for configuring resources according to some embodiments of the present disclosure. For example, the method is applicable to a terminal. The method includes at least part of the following processes.

In process 620, configuration signaling is received, wherein the configuration signaling includes at least one of a configuration of frequency domain resources or a configuration of time domain resources of an SL PRS resource pool.

The configuration signaling includes at least one of dynamic configuration signaling or pre-configuration signaling. The terminal receives the at least one of dynamic configuration signaling or pre-configuration signaling.

The time domain unit may be at least one of a frame, a subframe, a slot, a symbol group, a symbol, or a unit based on another time domain unit. In the present disclosure, for example, the time domain units are slots and symbols.

The frequency domain unit may be at least one of a carrier, a bandwidth part (BWP), a subband, a subchannel, a PRB, a subcarrier, or a unit based on another frequency domain unit. In the present disclosure, for example, the frequency domain units are BWPs, subchannels, and PRBs.

In some embodiments, the SL PRS resource pool is overlapped with at most with one SL communication resource pool in time-frequency domain resources.

In some embodiments, frequency domain resources for SL PRS transmission in each slot in the SL PRS resource pool are the same. In some embodiments, the frequency domain resources for SL PRS transmission in each slot in the SL PRS resource pool are determined in a first frequency domain configuration mode, or determined in a second frequency domain configuration mode, or determined in a third frequency domain configuration mode.

In some embodiments, the first frequency domain configuration mode is a configuration mode based on a first SL BWP, and frequency domain resources in the first SL BWP are frequency domain resources for SL PRS transmission. The first SL BWP is the same as a second SL BWP, the first SL BWP is a BWP for SL PRS transmission, PRBs in the first SL BWP are frequency domain resources for SL PRS transmission, wherein the second SL BWP is a BWP for SL communication.

In some embodiments, the second frequency domain configuration mode is a configuration mode based on one frequency domain resource group, the frequency domain resource group includes a plurality of contiguous PRBs, and frequency domain resources in the frequency domain resource group are frequency domain resources for SL PRS transmission. The plurality of PRBs are part of PRBs in a second SL BWP, wherein the second SL BWP is a BWP for SL communication.

In some embodiments, the third frequency domain configuration mode is a configuration mode based on at least two frequency domain resource groups, each of the at least two frequency domain resource groups includes a plurality of contiguous PRBs, and frequency domain resources in the at least two frequency domain resource groups are frequency domain resources for SL PRS transmission. The plurality of PRBs are part of PRBs in a second SL BWP, wherein the second SL BWP is a BWP for SL communication.

In some embodiments, frequency domain resources for SL PRS transmission in different types of slots in the SL PRS resource pool are different or not exactly the same. In some embodiments, the different types of slots in the SL PRS resource pool include at least two of:
first-type slots, including all or part of synchronized slots in the SL PRS resource pool;
second-type slots, including all or part of reserved slots in the SL PRS resource pool; or
third-type slots, including the remaining slots in the SL PRS resource pool except the synchronized slots and the reserved slots.

In some embodiments, first frequency domain resources for SL PRS transmission in the first-type slots are determined based on a third frequency domain configuration mode; second frequency domain resources for SL PRS transmission in the second-type slots are determined based on a first frequency domain configuration mode; and third frequency domain resources for SL PRS transmission in the third-type slots are determined based on a second frequency domain configuration mode or the third frequency domain configuration mode.

In some embodiments, third frequency domain resources for SL PRS transmission in the third-type slots are determined based on a first frequency domain configuration mode or a second frequency domain configuration mode; second frequency domain resources for SL PRS transmission in the second-type slots are determined based on the first frequency domain configuration mode or the second frequency domain configuration mode; and first frequency domain resources for SL PRS transmission in the first-type slots are determined based on the third frequency domain resources and frequency domain resources of a sidelink SSB (S_SSB).

In some embodiments, the first frequency domain resources include frequency domain resources that are in the third frequency domain resources and at different positions from the frequency domain resources of the S_SSB.

In some embodiments, the different types of slots are determined in a first logical slot set based on a bitmap; wherein the first logical slot set is acquired by excluding slots unavailable for SL transmission within one time domain period. If at least one of time domain symbols A, A+1, A+2, . . . , A+B−1 included in one slot is not configured as a UL symbol, the slot cannot be used for SL transmission, wherein A and B respectively represent sl-StartSymbol and sl-LengthSymbols.

In some embodiments, the first-type slots are determined in synchronized slots within a time domain period based on a first bitmap; the second-type slots are determined in reserved slots within the time domain period based on a second bitmap; and the third-type slots are determined in a second logical slot set based on a third bitmap. The second logical slot set is acquired by excluding the synchronized slots, the reserved slots, and the slots unavailable for SL transmission within one time domain period.

In some embodiments, the first-type slots include all synchronized slots; the second-type slots are determined in reserved slots within a time domain period based on a second bitmap; and the third-type slots are determined in a second logical slot set based on a third bitmap. The second logical slot set is acquired by excluding the synchronized slots, the reserved slots, and the slots unavailable for SL transmission within one time domain period.

In some embodiments, a frequency domain resource of a first PSCCH that schedules a transmission resource or a reserved resource of an SL PRS is located in an overlapped PRB in a plurality of PRBs, and the overlapped PRB is a PRB in which a transmission frequency domain resource of the SL PRS is overlapped with frequency domain resources of the SL communication resource pool.

In some embodiments, a frequency resource assignment of the first PSCCH is all subchannels in which a transmission bandwidth of the SL PRS is overlapped with a transmission bandwidth of the SL communication resource pool.

In some embodiments, the SL PRS resource pool is the same as the SL communication resource pool.

In some embodiments, frequency domain resources for SL PRS transmission in the SL PRS resource pool include: PRBs for SL communication and PRBs not for SL communication in the SL communication resource pool.

In some embodiments, a frequency domain resource of a second PSCCH that schedules a transmission resource or a reserved resource of an SL PRS is located in a 1st PRB for SL PRS transmission.

In some embodiments, a frequency resource assignment of the second PSCCH is all subchannels in which a transmission bandwidth of the SL PRS is overlapped with a transmission bandwidth of the SL communication resource pool.

In summary, in the method according to the embodiments of the present disclosure, at least one of the frequency domain resources or the time domain resources of the SL PRS resource pool is flexibly configured using the configuration signaling, which supports configuring different frequency domain resources and/or time domain resources for SL PRS and SL communication, prevents mutual influences between signals and channels of SL PRS and SL communication, and improves effectiveness of SL communication resources; and also supports configuring same or overlapped frequency domain resources and/or time domain resources for SL PRS and SL communication, and improves utilization of SL communication resources.

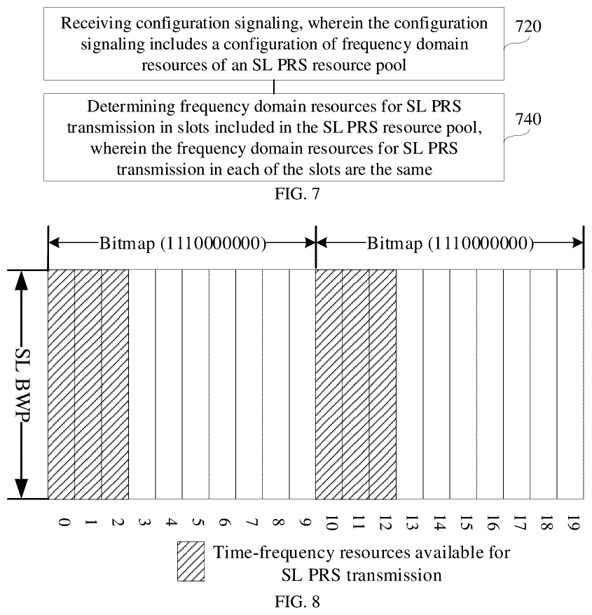

FIG. 7 is a schematic flowchart of a method for configuring resources according to some embodiments of the present disclosure. For example, the method is applicable to a terminal. The method includes at least part of the following processes.

In process 720, configuration signaling is received, wherein the configuration signaling includes a configuration of frequency domain resources of an SL PRS resource pool.

The configuration signaling includes at least one of dynamic configuration signaling or pre-configuration signaling. The terminal receives the at least one of dynamic configuration signaling or pre-configuration signaling.

In process 740, frequency domain resources for SL PRS transmission are determined in slots included in the SL PRS resource pool, and the frequency domain resources for SL PRS transmission in each of the slots are the same.

In some embodiments, the frequency domain resources for SL PRS transmission in each of the slots in the SL PRS resource pool are determined in a first frequency domain configuration mode, or determined in a second frequency domain configuration mode, or determined in a third frequency domain configuration mode.

In some embodiments, the first frequency domain configuration mode is a configuration mode based on a first SL BWP, and frequency domain resources in the first SL BWP are frequency domain resources for SL PRS transmission. The first SL BWP is the same as a second SL BWP, the first SL BWP is a BWP for SL PRS transmission, PRBs in the first SL BWP are frequency domain resources for SL PRS transmission, wherein the second SL BWP is a BWP for SL communication.

In some embodiments, as illustrated in FIG. 8, slots #0, #1, #2, #10, #11, #12 . . . are the slots included in the SL PRS resource pool. In some embodiments, these slots do not include slots for S_SSB transmission. That is, the terminal excludes slots for configuring S_SSB resources when determining the SL PRS resource pool. The configuration signaling or the pre-configuration signaling indicates that frequency domain resources in the first SL BWP are frequency domain resources for SL PRS transmission. The first SL BWP is the same as a configured or pre-configured second SL BWP. That is, the frequency domain resources for SL PRS transmission in each of the slots included in the SL PRS resource pool are all frequency domain resources in the first SL BWP.

Therefore, the first frequency domain configuration mode is conducive to maximum possibly ensuring a transmission bandwidth of the SL PRS. As illustrated in FIG. 8, the transmission bandwidth of the SL PRS is all of the second SL BWP.

In some embodiments, the second frequency domain configuration mode is a configuration mode based on one frequency domain resource group, wherein the frequency domain resource group includes a plurality of contiguous PRBs, and frequency domain resources in the frequency domain resource group are frequency domain resources for SL PRS transmission. The plurality of PRBs are part of PRBs in a second SL BWP, wherein the second SL BWP is a BWP for SL communication.

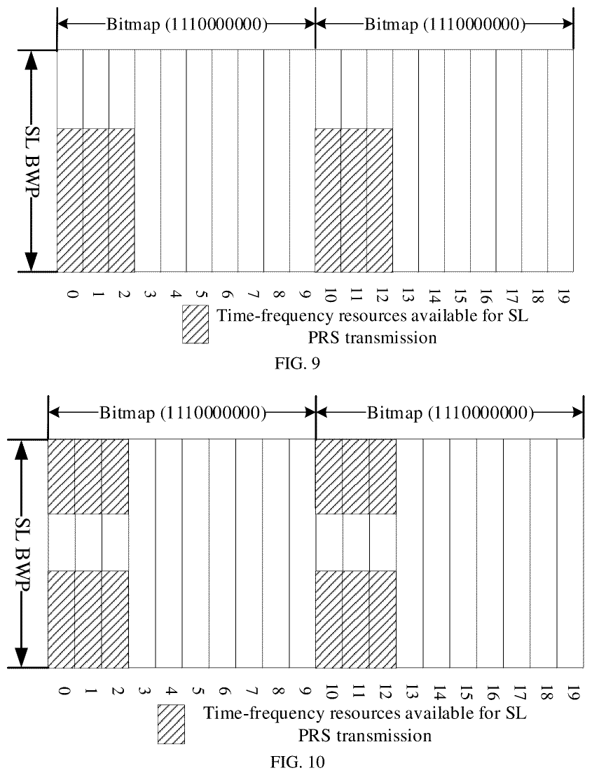

In some embodiments, as illustrated in FIG. 9, slots #0, #1, #2, #10, #11, #12 . . . are the slots included in the SL PRS resource pool. In some embodiments, these slots do not include slots for S_SSB transmission. That is, the terminal excludes slots for configuring S_SSB resources when determining the SL PRS resource pool. The configuration signaling or the pre-configuration signaling indicates that frequency domain resources in one frequency domain resource group are frequency domain resources for SL PRS transmission. The frequency domain resource group includes a plurality of contiguous PRBs. The plurality of PRBs are part of PRBs in the second SL BWP. That is, the frequency domain resources for SL PRS transmission in each slot included in the SL PRS resource pool are frequency domain resources in the frequency domain resource group.

Therefore, the second frequency domain configuration mode is conducive to using part of the frequency domain resources in one slot for SL PRS transmission, which prevents occupation of frequency domain resources of other SL communication resource pools including the slot and prevents mutual influences between SL PRS and SL communication. As illustrated in FIG. 9, the transmission bandwidth of the SL PRS is a BWP available for SL PRS transmission in the second SL BWP.

In some embodiments, the third frequency domain configuration mode is a configuration mode based on at least two frequency domain resource groups, wherein each of the at least two frequency domain resource groups includes a plurality of contiguous PRBs, and frequency domain resources in the at least two frequency domain resource groups are frequency domain resources for SL PRS transmission. The plurality of PRBs are part of PRBs in a second SL BWP, wherein the second SL BWP is a BWP for SL communication.

In some embodiments, as illustrated in FIG. 10, slots #0, #1, #2, #10, #11, #12 . . . are the slots included in the SL PRS resource pool. In some embodiments, these slots do not include slots for S_SSB transmission. That is, the terminal excludes slots for configuring S_SSB resources when determining the SL PRS resource pool. The configuration signaling or the pre-configuration signaling indicates that frequency domain resources in at least two frequency domain resource groups are frequency domain resources for SL PRS transmission. The frequency domain resource group includes a plurality of contiguous PRBs. The plurality of PRBs are part of PRBs in the second SL BWP. That is, the frequency domain resources for SL PRS transmission in each slot included in the SL PRS resource pool are frequency domain resources in the at least two frequency domain resource groups.

Therefore, the third frequency domain configuration mode supports more flexible configuration of part of the frequency domain resources in one slot for the SL PRS, which prevents occupation of the same frequency domain resources as other SL communications in the slot and prevents mutual influences between SL PRS and SL communication. As illustrated in FIG. 10, the transmission bandwidth of the SL PRS is two groups of BWPs available for SL PRS transmission in the second SL BWP.

In some embodiments, the terminal determines a transmission bandwidth of the SL PRS in one SL PRS resource pool by receiving the configuration signaling or the pre-configuration signaling. For example, the transmission bandwidth of the SL PRS is all PRBs included in the SL PRS resource pool.

In some embodiments, the SL PRS resource pool is overlapped in time and frequency domains with a resource pool for SL communication. In this case, if resources for SL PRS transmission reserved by the terminal overlap with the resources in the SL communication resource pool, a PSCCH should be transmitted over resources where the SL communication resource pool is located to indicate reservation information. Due to limitations on capabilities, the terminal can at most transmit only one PSCCH in the same slot. Therefore, the SL PRS can at most overlap in the time and frequency domains with only one SL communication resource pool.

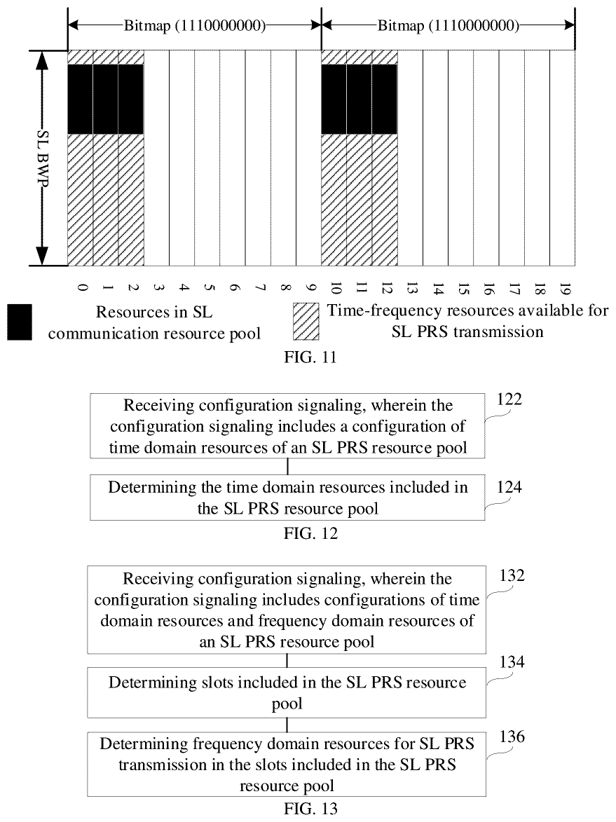

Taking the first frequency domain configuration mode as an example, part of time-frequency resources in the SL PRS resource pool may belong to one SL communication resource pool, as illustrated in FIG. 11. The terminal determines related configurations of the SL communication resource pool using the configuration signaling or the pre-configuration signaling, wherein the related configurations include the number of OFDM symbols and the number of PRBs occupied by the PSCCH in the SL communication resource pool.

When the terminal transmits the PSCCH to indicate the reservation information of SL PRS resources, the terminal transmits the PSCCH in the 1st subchannel reserved for SL PRS transmission in the SL PRS resource pool. A frequency resource assignment of the PSCCH is set to all subchannels in which the transmission bandwidth of the SL PRS is overlapped with the bandwidth of the SL communication resource pool. The subchannels are subchannels configured in the SL communication resource pool.

In summary, in the method according to the embodiments, flexible configuration of frequency domain resources of an SL PRS is supported, which can ensure a transmission bandwidth of the SL PRS without occupying frequency domain resources of SL communication, and prevents reduction of utilization or effectiveness of SL communication resources caused by mutual influences between SL PRS and SL communication.

FIG. 12 is a schematic flowchart of a method for configuring resources according to some embodiments of the present disclosure. For example, the method is applicable to a terminal. The method includes at least part of the following processes.

In process 122, configuration signaling is received, wherein the configuration signaling includes a configuration of time domain resources of an SL PRS resource pool.

The configuration signaling includes at least one of dynamic configuration signaling or pre-configuration signaling. The terminal receives the at least one of dynamic configuration signaling or the pre-configuration signaling.

In process 124, the time domain resources included in the SL PRS resource pool are determined.

Type of slots included in the time domain resources in the SL PRS resource pool are the same, or the time domain resources in the SL PRS resource pool include different types of slots.

In some embodiments, the different types of slots include at least two of:
first-type slots, including all or part of synchronized slots in the SL PRS resource pool;
second-type slots, including all or part of reserved slots in the SL PRS resource pool; or
third-type slots, including the remaining slots in the SL PRS resource pool except the synchronized slots and the reserved slots.

In the case that the SL PRS resource pool includes different types of slots, the time domain resource configuration mode at least includes: at least one of a first time domain resource configuration mode, a second time domain resource configuration mode, or a third time domain resource configuration mode. In some embodiments, the configuration signaling or the pre-configuration signaling includes at least one of the first time domain resource configuration mode, the second time domain resource configuration mode, or the third time domain resource configuration mode.

Next, the three time domain resource configuration modes are illustrated by taking one SFN period as an example.

### First Time Domain Resource Configuration Mode:

In process 1, slots not matching start points and number configurations of the UL symbols within one SFN period, that is, slots unavailable for SL transmission (i.e., N_{nonSL}), are removed. For example, if at least one of time domain symbols A, A+1, A+2, . . . , A+B−1 included in one slot is not semi-statically configured as a UL symbol, the slot cannot be used for SL transmission. A and B are configured by the configuration signaling or the pre-configuration signaling. In some embodiments, A and B are configured respectively by the configuration signaling or the pre-configuration signaling. The remaining slots are renumbered as (l₀, l₁, . . . , l_{(10240×2}_{^{μ}}_{-N}_{_{nonSL}}₋₁₎), referred to as a first logical slot set.

In process 2, slots in the first logical slot set that belong to the SL PRS resource pool are determined based on a bitmap. The bitmap in configuration information of the SL PRS resource pool is (b₀, b₁, . . . , b_{L}_{_{bitmap}}₋₁). With respect to a slot tₖ^{SL} (0≤k<(10240×2^{μ}−N_{nonSL})) in the first logical slot set, in the case that b_{k′}=1 is satisfied, the slot is a slot belonging to the SL PRS resource pool, wherein k′=k mod L_{bitmap}.

The slots in the first logical slot set that belong to the SL PRS resource pool include at least two of the first-type slots, the second-type slots, or the third-type slots.

### Second Time Domain Resource Configuration Mode:

In process 1, slots not belonging to the SL PRS resource pool within an SFN period are removed, including the number of synchronization slots (i.e., N_{S_SSB}) and the number of slots unavailable for SL transmission (i.e., N_{nonSL}). Remaining slots are represented as a set of the remaining slots, and the remaining slots are renumbered as

$$( {l}_{0} , {l}_{1} , … , {l}_{( 10240 \times {2}^{μ} - {N}_{S \_ SSB} - {N}_{nonSL} - 1 )} ) .$$

N_{S_SSB} represents the number of synchronization slots within one SFN period; and the synchronization slots are determined based on synchronization-related configuration parameters and are related to a period of transmission of SSBs and the number of SSB transmission resources configured in the period.

N_{nonSL} represents the number of slots not matching start points and number configurations of the UL symbols within one SFN period: in the case that at least one of time domain symbols A, A+1, A+2, . . . , A+B−1 included in one slot is not semi-statically configured as a UL symbol, the slot cannot be used for SL transmission. A and B are configured by the configuration signaling or the pre-configuration signaling. In some embodiments, A and B are configured respectively by the configuration signaling or the pre-configuration signaling.

In process 2, the number of reserved slots and corresponding time domain positions are determined.

If the number of slots in the set of the remaining slots cannot be evenly divided by the length of the bitmap, the number of reserved slots and the corresponding time domain positions need to be determined. For example, in the case that a slot lᵣ (0≤r<10240×2^{μ}−N_{S_SSB}−N_{nonSL}) meets the following condition, the slot is a reserved slot,

$$r = ⌊ \frac{m \cdot ( 10240 \times {2}^{μ} - {N}_{S \_ SSB} - {N}_{nonSL} )}{{N}_{reserved}} ⌋$$

wherein
N_{reserved}=(10240×2^{μ}−N_{S_SSB}−N_{nonSL}) mod L_{bitmap}, N_{reserved} represents the number of reserved slots, L_{bitmap} represents the length of the bitmap, and m=0, . . . , N_{reserved}−1.

In process 3, the reserved slots are removed from the set of the remaining slots, and the set of the remaining slots is represented as a second logical slot set, wherein all the slots in the second logical slot set are slots available for the SL PRS resource pool, and the slots in the second logical slot set are renumbered as (t₀^{SL}, t₁^{SL}, . . . , t_{T}_{ₘₐₓ}₋₁^{SL}), wherein Tₘₐₓ=10240×2^{μ}−N_{S_SSB}−N_{nonSL}−N_{reserved}.

In process 4, slots in the second logical slot set that belong to the SL PRS resource pool are determined based on a first bitmap.

The bitmap in configuration information of the SL PRS resource pool is (b₀, b₁, . . . , b_{L}_{_{bitmap}}₋₁). With respect to a slot tₖ^{SL} (0≤k<(10240×2^{μ}−N_{S_SSB}−N_{nonSL}−N_{reserved})) in the second logical slot set, in the case that b_{k′}=1 is satisfied, the slot is a slot belonging to the SL PRS resource pool, wherein k′=k mod L_{bitmap}. The slots in the second logical slot set that belong to the SL PRS resource pool are referred to as the third-type slots.

In process 5, slots belonging to the SL PRS resource pool and in N_{S_SSB} synchronization slot sets are determined based on a second bitmap, wherein a length of the second bitmap is N_{S_SSB} or the number of S_SSB resources in one synchronization resource period (i.e., 160 ms). The slots belonging to the SL PRS resource pool and in the synchronization slot sets are referred to as the first-type slots.

In process 6, slots belonging to the SL PRS resource pool and in N_{reserved} reserved slot sets are determined based on a third bitmap, wherein a length of the third bitmap is L_{bitmap} or N_{reserved}. The slots belonging to the SL PRS resource pool and in the reserved slot sets are referred to as the second-type slot.

In some embodiments, process 5 is performed before process 1 or after process 6.

### Third Time Domain Resource Configuration Mode:

In process 1, slots not belonging to the SL PRS resource pool in an SFN period are removed, including the number of synchronization slots (i.e., N_{S_SSB}) and the number of slots unavailable for SL transmission (i.e., N_{nonSL}). Remaining slots are represented as a set of the remaining slots, and the remaining slots are renumbered as

$$( {l}_{0} , {l}_{1} , … , {l}_{( 10240 \times {2}^{μ} - {N}_{S \_ SSB} - {N}_{nonSL} - 1 )} ) .$$

N_{S_SSB} represents the number of synchronization slots within one SFN period; and the synchronization slots are determined based on synchronization-related configuration parameters and are related to a period of transmission of SSBs and the number of SSB transmission resources configured in the period.

N_{nonSL} represents the number of slots not matching the start points and number configurations of the UL symbols within one SFN period: in the case that at least one of time domain symbols A, A+1, A+2, . . . , A+B−1 included in one slot is not semi-statically configured as a UL symbol, the slot cannot be used for SL transmission. A and B are configured by the configuration signaling or the pre-configuration signaling. In some embodiments, A and B are configured respectively by the configuration signaling or the pre-configuration signaling.

In process 2, the number of reserved slots and corresponding time domain positions are determined.

In the case that the number of slots in the set of the remaining slots cannot be evenly divided by the length of the bitmap, the number of reserved slots and the corresponding time domain positions need to be determined. For example, in the case that a slot lᵣ (0≤r<10240×2^{μ}−N_{S_SSB}−N_{nonSL}) meets the following condition, the slot is a reserved slot,

$$r = ⌊ \frac{m \cdot ( 10240 \times {2}^{μ} - {N}_{S \_ SSB} - {N}_{nonSL} )}{{N}_{reserved}} ⌋$$

wherein
N_{reserved}=(10240×2^{μ}−N_{S_SSB}−N_{nonSL}) mod L_{bitmap}, N_{reserved} represents the number of reserved slots, L_{bitmap} represents the length of the bitmap, and m=0, . . . , N_{reserved}−1.

In process 3, the reserved slots are removed from the set of the remaining slots, and the set of the remaining slots is represented as a second logical slot set, wherein all the slots in the second logical slot set are slots available for the SL PRS resource pool, and the slots in the second logical slot set are renumbered as (t₀^{SL}, t₁^{SL}, . . . , t_{T}_{ₘₐₓ}₋₁^{SL}), wherein Tₘₐₓ=10240×2^{μ}−N_{S_SSB}−N_{nonSL}−N_{reserved}.

In process 4, slots in the second logical slot set that belong to the SL PRS resource pool are determined based on a first bitmap.

The bitmap in configuration information of the SL PRS resource pool is (b₀, b₁, . . . , b_{L}_{_{bitmap}}₋₁). With respect to a slot tₖ^{SL} (0≤k<(10240×2^{μ}−N_{S_SSB}−N_{nonSL}−N_{reserved})) in the second logical slot set, in the case that b_{k′}=1 is satisfied, the slot is a slot belonging to the SL PRS resource pool, wherein k′=k mod L_{bitmap}. The slots in the second logical slot set that belong to the SL PRS resource pool are referred to as the third-type slots.

In process 5, slots belonging to the SL PRS resource pool and in N_{reserved} reserved slot sets are determined based on a third bitmap, wherein a length of the third bitmap is L_{bitmap} or N_{reserved}. The slots belonging to the SL PRS resource pool and in the reserved slot sets are referred to as the second-type slot. The third-type slots and the first-type slots may be referred to as a first slot set.

In process 6, all synchronization slots are referred to as the first-type slots.

The slots included in the SL PRS resource pool are categorized into the first slot set and the first-type slots.

In some embodiments, the configuration signaling or the pre-configuration signaling includes the reserved slots of the SL PRS resource pool.

In summary, in the method according to the embodiments of the present disclosure, flexible slot resource configuration modes are supported, and the same type or different types of slots are configured for an SL PRS resource pool, thereby meeting requirements for time domain resources in different SL communication scenarios and improving utilization and effectiveness of time domain resources.

FIG. 13 is a schematic flowchart of a method for configuring resources according to some embodiments of the present disclosure. For example, the method is applicable to a terminal. The method includes at least part of the following processes.

In process 132, configuration signaling is received, wherein the configuration signaling includes configurations of time domain resources and frequency domain resources of an SL PRS resource pool.

The configuration signaling includes at least one of dynamic configuration signaling or pre-configuration signaling. The terminal receives the at least one of dynamic configuration signaling or the pre-configuration signaling.

In process 134, slots included in the SL PRS resource pool are determined.

In some embodiments, the types of slots included in the time domain resources in the SL PRS resource pool are the same, or the time domain resources in the SL PRS resource pool include different types of slots.

In some embodiments, the different types of slots include at least two of:
first-type slots, including all or part of synchronized slots in the SL PRS resource pool;
second-type slots, including all or part of reserved slots in the SL PRS resource pool; or
third-type slots, including the remaining slots in the SL PRS resource pool except the synchronized slots and the reserved slots.

In the case that the SL PRS resource pool includes different types of slots, the time domain resource configuration mode at least includes: at least one of the first time domain resource configuration mode, the second time domain resource configuration mode, or the third time domain resource configuration mode as described above. In some embodiments, the configuration signaling or the pre-configuration signaling includes at least one of the first time domain resource configuration mode, the second time domain resource configuration mode, or the third time domain resource configuration mode as described above.

In process 136, frequency domain resources for SL PRS transmission in the slots included in the SL PRS resource pool are determined.

In the case that the types of slots included in the SL PRS resource pool are the same, the frequency domain resources for SL PRS transmission in each of the slots in the SL PRS resource pool are determined using the configuration method as illustrated in FIG. 7. Details are not described herein.

In the case that the SL PRS resource pool includes different types of slots, the frequency domain resources for SL PRS transmission in each of the slots in the SL PRS resource pool are determined in at least two of the following manners. Description is given in the embodiments based on an example in which the SL PRS resource pool includes the first-type slots, the second-type slots, and the third-type slots.

In the first manner, the frequency domain resources available for SL PRS transmission in the first-type slots are configured in the third frequency domain resource configuration mode, the frequency domain resources available for SL PRS transmission in the second-type slots are configured in the first frequency domain resource configuration mode, and the frequency domain resources available for SL PRS transmission in the third-type slots are configured in the second frequency domain resource configuration mode or the third frequency domain resource configuration mode. The frequency domain resources available for SL PRS transmission in the three types of slots are configured by the configuration signaling or the pre-configuration signaling.

In some embodiments, the configuration signaling or the pre-configuration signaling includes separately configuring the frequency domain resources for SL PRS transmission in the first-type slots, the second-type slots, and the third-type slots; or not separately configuring the frequency domain resources for SL PRS transmission in the first-type slots, the second-type slots, and the third-type slots.

In the second manner, the frequency domain resources available for SL PRS transmission in the third-type slots are configured in the first frequency domain resource configuration mode or the second frequency domain resource configuration mode, first frequency domain resources for SL PRS transmission in the first-type slots are determined based on third frequency domain resources and frequency domain resources of the S_SSB, that is, frequency domain resources that are not at the same position as the frequency domain resources of the S_SSB and in resources available for SL PRS transmission in the third-type slots are the frequency domain resources available for SL PRS transmission in the first-type slots, and the frequency domain resources available for SL PRS transmission in the second-type slots are configured in the first frequency domain resource configuration mode or the second frequency domain resource configuration mode.

In some embodiments, the configuration signaling or the pre-configuration signaling includes separately configuring the frequency domain resources for SL PRS transmission in the second-type slots and the third-type slots; or not separately configuring the frequency domain resources for SL PRS transmission in the second-type slots and the third-type slots. In some embodiments, the frequency domain resources available for SL PRS transmission in the second-type slots and the third-type slots are separately configured by the configuration signaling or the pre-configuration signaling, the frequency domain resources available for SL PRS transmission in the third-type slots are configured by first signaling in the second frequency domain resource configuration mode, and the frequency domain resources available for SL PRS transmission in the second-type slots are configured by second signaling in the first frequency domain resource configuration mode.

With respect to the second-type and third-type slots, the resources for SL PRS transmission may be located in a configured or pre-configured SL communication resource pool. If resources for SL PRS transmission reserved by the terminal overlap with the resources in the SL communication resource pool, a PSCCH should be transmitted over resources where the SL communication resource pool is located to indicate the reservation information. Due to limitations on capabilities, the terminal can at most transmit only one PSCCH in the same slot. Therefore, the SL PRS can at most overlap in the time and frequency domains with only one SL communication resource pool. In some embodiments, the terminal determines related configurations of the SL communication resource pool using the configuration signaling or the pre-configuration signaling, wherein the related configurations include the number of OFDM symbols and the number of PRBs occupied by the PSCCH in the SL communication resource pool.

When the terminal transmits the PSCCH to indicate the reservation information of SL PRS resources, the terminal transmits the PSCCH in the 1st subchannel reserved for SL PRS transmission in the SL PRS resource pool. A frequency resource assignment of the PSCCH is set to all subchannels in which the transmission bandwidth of the SL PRS is overlapped with the bandwidth of the SL communication resource pool. The subchannels are subchannels configured in the SL communication resource pool.

In summary, in the method according to the embodiments, flexible configuration of frequency domain resources of an SL PRS for different types of slots in different frequency domain resource configuration modes is supported, which can ensure a transmission bandwidth of the SL PRS without occupying frequency domain resources of SL communication when available frequency domain resources on different types of slots are different, thereby preventing reduction of utilization or effectiveness of SL communication resources caused by mutual influences between SL PRS and SL communication.

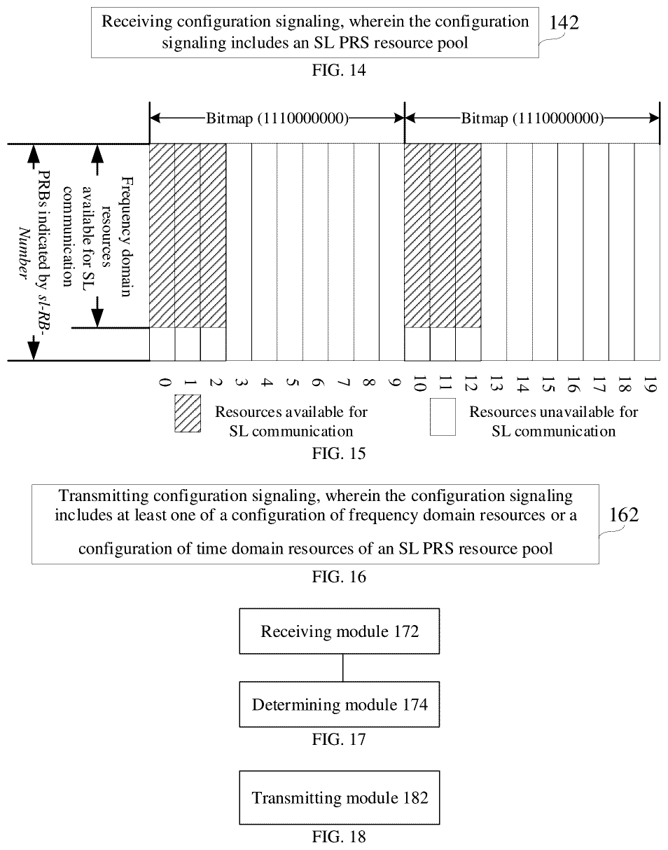

FIG. 14 is a schematic flowchart of a method for configuring resources according to some embodiments of the present disclosure. For example, the method is applicable to a terminal. The method includes at least part of the following processes.

In process 142, configuration signaling is received, wherein the configuration signaling includes an SL PRS resource pool.

The configuration signaling includes at least one of dynamic configuration signaling or pre-configuration signaling. The terminal receives the at least one of dynamic configuration signaling or the pre-configuration signaling.

In the embodiments, the SL PRS resource pool is the same as the SL communication resource pool. That is, one SL communication resource pool is used for SL PRS transmission. Frequency domain resources for SL PRS transmission in the SL PRS resource pool include: PRBs available for SL communication and PRBs unavailable for SL communication in the SL communication resource pool. That is, all the PRBs included in the SL communication resource pool may be used for SL PRS transmission. The number of PRBs included in the SL communication resource pool is indicated by the configuration signaling or the pre-configuration signaling.

In some embodiments, as illustrated in FIG. 15, the configuration signaling or the pre-configuration signaling indicates the number of PRBs included in the SL communication resource pool. In some embodiments, the configuration signaling or the pre-configuration signaling is a radio resource control (RRC) layer configuration parameter, such as sl-RB-Number. The frequency domain resources actually available for SL communication are Y contiguous subchannels starting from an Xth PRB, wherein X is indicated by the configuration signaling or the pre-configuration signaling, for example, by an RRC layer configuration parameter sl-StartRB-Subchannel, and Y is indicated by the configuration signaling or the pre-configuration signaling, for example, by an RRC layer configuration parameter sl-NumSubchannel. In the case that X×Y is less than the number of PRBs indicated by sl-RB-Number, remaining PRBs cannot be used for SL communication. Frequency domain resources available for SL PRS transmission include frequency domain resources available for SL communication and frequency domain resources unavailable for SL communication in the SL communication resource pool.

In the embodiments, a start point of the frequency domain resources for SL PRS transmission is a start point of one subchannel of the SL communication resource pool, or a start point of one PRB; and an end point of the frequency domain resources for SL PRS transmission is an end point of one subchannel of the SL communication resource pool, or an end point of one PRB.

The terminal transmits a PSCCH in the 1st subchannel for SL PRS transmission to indicate a transmission resource or a reserved resource of SL PRS, and a frequency resource assignment of the PSCCH is set to all subchannels in which the transmission bandwidth of the SL PRS is overlapped with the bandwidth of the SL communication resource pool. The subchannels are subchannels configured in the SL communication resource pool. In some embodiments, the terminal determines related configurations of the SL communication resource pool using the configuration signaling or the pre-configuration signaling, wherein the related configurations include the number of OFDM symbols and the number of PRBs occupied by the PSCCH in the SL communication resource pool.

When the terminal transmits the PSCCH to indicate the reservation information of SL PRS resources, the terminal transmits the PSCCH in the 1st subchannel reserved for SL PRS transmission in the SL PRS resource pool. A frequency resource assignment of the PSCCH is set to all subchannels in which the transmission bandwidth of the SL PRS is overlapped with the bandwidth of the SL communication resource pool. The subchannels are subchannels configured in the SL communication resource pool. For example, in the case that the transmission bandwidth of the SL PRS is configured or pre-configured as frequency domain resources in the entire SL PRS resource pool, the frequency resource assignment of the PSCCH is set to X×Y PRBs.

In summary, in the method according to the embodiments, configuration of the SL communication resource pool as an SL PRS resource pool is supported, which helps to improve utilization of SL resources.

FIG. 16 is a schematic flowchart of a method for configuring resources according to some embodiments of the present disclosure. For example, the method is applicable to a network device. The method includes at least part of the following processes.

In process 162, configuration signaling is transmitted, wherein the configuration signaling includes at least one of a configuration of frequency domain resources or a configuration of time domain resources of an SL PRS resource pool.

The configuration signaling includes at least one of dynamic configuration signaling or pre-configuration signaling. The network device transmits the at least one of dynamic configuration signaling or the pre-configuration signaling to a terminal.

The time domain unit may be at least one of a frame, a subframe, a slot, a symbol group, a symbol, or a unit based on another time domain unit. In the present disclosure, for example, the time domain units are slots and symbols.

The frequency domain unit may be at least one of a carrier, a BWP, a subband, a subchannel, a PRB, a subcarrier, or a unit based on another frequency domain unit. In the present disclosure, for example, the frequency domain units are BWPs, subchannels, and PRBs.

In some embodiments, the SL PRS resource pool is overlapped with at most with one SL communication resource pool in time-frequency domain resources.

In some embodiments, frequency domain resources for SL PRS transmission in each slot in the SL PRS resource pool are the same. In some embodiments, the frequency domain resources for SL PRS transmission in each slot in the SL PRS resource pool are determined in a first frequency domain configuration mode, or determined in a second frequency domain configuration mode, or determined in a third frequency domain configuration mode.

In some embodiments, the first frequency domain configuration mode is a configuration mode based on a first SL BWP, and frequency domain resources in the first SL BWP are frequency domain resources for SL PRS transmission. The first SL BWP is the same as a second SL BWP, the first SL BWP is a BWP for SL PRS transmission, PRBs in the first SL BWP are frequency domain resources for SL PRS transmission, wherein the second SL BWP is a BWP for SL communication.

In some embodiments, the second frequency domain configuration mode is a configuration mode based on one frequency domain resource group, wherein the frequency domain resource group includes a plurality of contiguous PRBs, and frequency domain resources in the frequency domain resource group are frequency domain resources for SL PRS transmission. The plurality of PRBs are part of PRBs in a second SL BWP, wherein the second SL BWP is a BWP for SL communication.

In some embodiments, the third frequency domain configuration mode is a configuration mode based on at least two frequency domain resource groups, wherein each of the at least two frequency domain resource groups includes a plurality of contiguous PRBs, and frequency domain resources in the at least two frequency domain resource groups are frequency domain resources for SL PRS transmission. The plurality of PRBs are part of PRBs in a second SL BWP, wherein the second SL BWP is a BWP for SL communication.

In some embodiments, frequency domain resources for SL PRS transmission in different types of slots in the SL PRS resource pool are different or not exactly the same. In some embodiments, the different types of slots in the SL PRS resource pool include at least two of:
first-type slots, including all or part of synchronized slots in the SL PRS resource pool;
second-type slots, including all or part of reserved slots in the SL PRS resource pool; or
third-type slots, including the remaining slots in the SL PRS resource pool except the synchronized slots and the reserved slots.

In some embodiments, first frequency domain resources for SL PRS transmission in the first-type slots are determined based on a third frequency domain configuration mode; second frequency domain resources for SL PRS transmission in the second-type slots are determined based on a first frequency domain configuration mode; and third frequency domain resources for SL PRS transmission in the third-type slots are determined based on a second frequency domain configuration mode or the third frequency domain configuration mode.

In some embodiments, third frequency domain resources for SL PRS transmission in the third-type slots are determined based on a first frequency domain configuration mode or a second frequency domain configuration mode; second frequency domain resources for SL PRS transmission in the second-type slots are determined based on the first frequency domain configuration mode or the second frequency domain configuration mode; and first frequency domain resources for SL PRS transmission in the first-type slots are determined based on the third frequency domain resources and frequency domain resources of an S_SSB.

In some embodiments, the first frequency domain resources include frequency domain resources that are in the third frequency domain resources and at different positions from the frequency domain resources of the S_SSB.

In some embodiments, the different types of slots are determined in a first logical slot set based on a bitmap; wherein the first logical slot set is acquired by excluding slots unavailable for SL transmission within one time domain period. The slots unavailable for SL transmission include, but are not limited to, slots in which at least one of time domain symbols is not configured as a UL symbol, slots outside an SL transmission range that are indicated by configuration signaling, and the like.

In some embodiments, the first-type slots are determined in synchronized slots within a time domain period based on a first bitmap; the second-type slots are determined in reserved slots within the time domain period based on a second bitmap; and the third-type slots are determined in a second logical slot set based on a third bitmap. The second logical slot set is acquired by excluding the synchronized slots, the reserved slots, and slots unavailable for SL transmission within one time domain period.

In some embodiments, the first-type slots include all synchronized slots; the second-type slots are determined in reserved slots within a time domain period based on a second bitmap; and the third-type slots are determined in a second logical slot set based on a third bitmap. The second logical slot set is acquired by excluding the synchronized slots, the reserved slots, and the slots unavailable for SL transmission within one time domain period.

In some embodiments, a frequency domain resource in a first PSCCH that schedules a transmission resource or a reserved resource of an SL PRS is located in an overlapped PRB in a plurality of PRBs, and the overlapped PRB is a PRB in which a transmission frequency domain resource of the SL PRS is overlapped with frequency domain resources of the SL communication resource pool.

In some embodiments, a frequency resource assignment of the first PSCCH is all subchannels in which a transmission bandwidth of the SL PRS is overlapped with a transmission bandwidth of the SL communication resource pool.

In some embodiments, the SL PRS resource pool is the same as the SL communication resource pool.

In some embodiments, frequency domain resources for SL PRS transmission in the SL PRS resource pool include: PRBs for SL communication and PRBs not for SL communication in the SL communication resource pool.

In some embodiments, a frequency domain resource of a second PSCCH that schedules a transmission resource or a reserved resource of an SL PRS is located in a 1st PRB for SL PRS transmission.

In some embodiments, a frequency resource assignment of the second PSCCH is all subchannels in which a transmission bandwidth of the SL PRS is overlapped with a transmission bandwidth of the SL communication resource pool.

In summary, in the method according to the embodiments of the present disclosure, the frequency domain resources and/or the time domain resources of the SL PRS resource pool are flexibly configured by the configuration signaling, which supports configuring different frequency domain resources and/or time domain resources for SL PRS and SL communication, prevents mutual influences between signals and channels for SL PRS and SL communication, and improves effectiveness of SL communication resources; and also supports configuring same or overlapped 4 frequency domain resources and/or time domain resources for SL PRS and SL communication, and improves utilization of SL communication resources.

FIG. 17 is a structural block diagram of an apparatus for configuring resources according to some embodiments of the present disclosure. For example, the apparatus for configuring resources is applied to a terminal. The apparatus for configuring resources includes a receiving module 172.

The receiving module 172 is configured to receive configuration signaling, wherein the configuration signaling includes at least one of a configuration of frequency domain resources or a configuration of time domain resources of an SL PRS resource pool.

In some embodiments, frequency domain resources for SL PRS transmission in each time domain unit in the SL PRS resource pool are the same.

In some embodiments, the apparatus further includes a determining module 174 configured to determine the frequency domain resources for SL PRS transmission in each time domain unit in a first frequency domain configuration mode, a second frequency domain configuration mode, or a third frequency domain configuration mode.

In some embodiments, frequency domain resources for SL PRS transmission in different types of time domain units in the SL PRS resource pool are different or not exactly the same.

In some embodiments, the different types of time domain units include at least two of:
first-type time domain units, including all or part of synchronization time domain units in the SL PRS resource pool;
second-type time domain units, including all or part of reserved time domain units in the SL PRS resource pool; or
third-type time domain units, including remaining time domain units in the SL PRS resource pool except the synchronization time domain units and the reserved time domain units.

In some embodiments, the determining module 174 is further configured to determine first frequency domain resources for SL PRS transmission in the first-type time domain units based on a third frequency domain configuration mode; determine second frequency domain resources for SL PRS transmission in the second-type time domain units based on a first frequency domain configuration mode; and determine third frequency domain resources for SL PRS transmission in the third-type time domain units based on a second frequency domain configuration mode or the third frequency domain configuration mode.

In some embodiments, the determining module 174 is further configured to determine third frequency domain resources for SL PRS transmission in the third-type time domain units based on a first frequency domain configuration mode or a second frequency domain configuration mode; determine second frequency domain resources for SL PRS transmission in the second-type time domain units based on the first frequency domain configuration mode or the second frequency domain configuration mode; and determine first frequency domain resources for SL PRS transmission in the first-type time domain units based on the third frequency domain resources and frequency domain resources of an S_SSB.

In some embodiments, the first frequency domain resources include frequency domain resources that are in the third frequency domain resources and at different positions from the frequency domain resources of the S_SSB.

In some embodiments, the first frequency domain configuration mode is a configuration mode based on a first SL BWP, and frequency domain resources in the first SL BWP are frequency domain resources for SL PRS transmission;
wherein the first SL BWP is the same as a second SL BWP, the first SL BWP is a BWP for SL PRS transmission, frequency domain units in the first SL BWP are frequency domain resources for SL PRS transmission, wherein the second SL BWP is a BWP for SL communication.

In some embodiments, the second frequency domain configuration mode is a configuration mode based on one frequency domain resource group, wherein the frequency domain resource group includes a plurality of contiguous frequency domain units, and frequency domain resources in the frequency domain resource group are frequency domain resources for SL PRS transmission.

In some embodiments, the third frequency domain configuration mode is a configuration mode based on at least two frequency domain resource groups, wherein each of the at least two frequency domain resource groups includes a plurality of contiguous frequency domain units, and frequency domain resources in the at least two frequency domain resource groups are frequency domain resources for SL PRS transmission.

In some embodiments, the plurality of frequency domain units are part of frequency domain units in a second SL BWP, wherein the second SL BWP is a BWP for SL communication.

In some embodiments, a frequency domain resource of a first PSCCH that schedules a transmission resource or a reserved resource of an SL PRS is located in an overlapped frequency domain unit in the plurality of frequency domain units, wherein the overlapped frequency domain unit is a frequency domain unit overlapping with frequency domain resources of an SL communication resource pool.

In some embodiments, a frequency resource assignment of the first PSCCH is all subchannels in which a transmission bandwidth of the SL PRS is overlapped with a transmission bandwidth of the SL communication resource pool.

In some embodiments, the determining module 174 is further configured to determine the different types of time domain units in a first logical time domain unit set based on a bitmap;
wherein the first logical time domain unit set is acquired by excluding time domain units unavailable for SL transmission within one time domain period.

In some embodiments, the determining module 174 is further configured to determine the first-type time domain units in synchronization time domain units within the time domain period based on a first bitmap; determine the second-type time domain units in reserved time domain units belonging to the time domain period based on a second bitmap; and determine the third-type time domain units in a second logical time domain unit set based on a third bitmap;
wherein the second logical time domain unit set is acquired by excluding the synchronization time domain units, the reserved time domain units, and the time domain units unavailable for SL transmission within one time domain period.

In some embodiments, the determining module 174 is further configured to determine that the first-type time domain units include all synchronization time domain units; determine the second-type time domain units in reserved time domain units within the time domain period based on a second bitmap; and determine the third-type time domain units in a second logical time domain unit set based on a third bitmap;
wherein the second logical time domain unit set is acquired by excluding the synchronization time domain units, the reserved time domain units, and the time domain units unavailable for SL transmission within one time domain period.

In some embodiments, the SL PRS resource pool is overlapped with at most with one SL communication resource pool in time-frequency domain resources.

In some embodiments, the SL PRS resource pool is the same as the SL communication resource pool.

In some embodiments, frequency domain resources for SL PRS transmission in the SL PRS resource pool include: frequency domain units for SL communication and frequency domain units not for SL communication in the SL communication resource pool.

In some embodiments, a frequency domain resource of a second PSCCH that schedules a transmission resource or a reserved resource of an SL PRS are located in a 1st frequency domain unit for SL PRS transmission.

In some embodiments, a frequency resource assignment of the second PSCCH is all subchannels in which a transmission bandwidth of the SL PRS is overlapped with a transmission bandwidth of the SL communication resource pool.

In summary, in the apparatus according to the embodiments of the present disclosure, the frequency domain resources and/or the time domain resources of the SL PRS resource pool are flexibly configured by the configuration signaling, which supports configuring different frequency domain resources and/or time domain resources for SL PRS and SL communication, prevents mutual influences between signals and channels for SL PRS and SL communication, and improves effectiveness of SL communication resources; and also supports configuring same or overlapped frequency domain resources and/or time domain resources for SL PRS and SL communication, and improves utilization of SL communication resources.

FIG. 18 is a structural block diagram of an apparatus for configuring resources according to some embodiments of the present disclosure. For example, the apparatus for configuring resources is applied to a network device. The apparatus for configuring resources includes a transmitting module 183.

The transmitting module 182 is configured to transmit configuration signaling, wherein the configuration signaling includes at least one of a configuration of frequency domain resources or a configuration of time domain resources of an SL PRS resource pool.

In some embodiments, frequency domain resources for SL PRS transmission in each time domain unit in the SL PRS resource pool are the same.

In some embodiments, the configuration signaling includes a first frequency domain configuration mode, a second frequency domain configuration mode, or a third frequency domain configuration mode that determines the frequency domain resources for SL PRS transmission in each time domain unit.

In some embodiments, frequency domain resources for SL PRS transmission in different types of time domain units in the SL PRS resource pool are different or not exactly the same.

In some embodiments, the different types of time domain units include at least two of:
first-type time domain units, including all or part of synchronization time domain units in the SL PRS resource pool;
second-type time domain units, including all or part of reserved time domain units in the SL PRS resource pool; or
third-type time domain units, including remaining time domain units in the SL PRS resource pool except the synchronization time domain units and the reserved time domain units.

In some embodiments, the configuration signaling includes:
a third frequency domain configuration mode, configured to determine first frequency domain resources for SL PRS transmission or third frequency domain resources for SL PRS transmission in the first-type time domain units;
a first frequency domain configuration mode, configured to determine second frequency domain resources for SL PRS transmission in the second-type time domain units; and
a second frequency domain configuration mode, configured to determine third frequency domain resources for SL PRS transmission in the third-type time domain units.

In some embodiments, the configuration signaling includes:
a first frequency domain configuration mode, configured to determine third frequency domain resources for SL PRS transmission in the third-type time domain units or determine second frequency domain resources for SL PRS transmission in the second-type time domain units; and
a second frequency domain configuration mode, configured to determine the second frequency domain resources for SL PRS transmission in the second-type time domain units or the third frequency domain resources for SL PRS transmission in the third-type time domain units; and
the configuration signaling is further configured to determine first frequency domain resources for SL PRS transmission in the first-type time domain units based on the third frequency domain resources and frequency domain resources of an S_SSB.

In some embodiments, the first frequency domain resources include frequency domain resources that are in the third frequency domain resources and at different positions from the frequency domain resources of the S_SSB.

In some embodiments, the first frequency domain configuration mode is a configuration mode based on a first SL BWP, and frequency domain resources in the first SL BWP are frequency domain resources for SL PRS transmission;
wherein the first SL BWP is the same as a second SL BWP, the first SL BWP is a BWP for SL PRS transmission, frequency domain units in the first SL BWP are frequency domain resources for SL PRS transmission, wherein the second SL BWP is a BWP for SL communication.

In some embodiments, the second frequency domain configuration mode is a configuration mode based on one frequency domain resource group, wherein the frequency domain resource group includes a plurality of contiguous frequency domain units, and frequency domain resources in the frequency domain resource group are frequency domain resources for SL PRS transmission.

In some embodiments, the third frequency domain configuration mode is a configuration mode based on at least two frequency domain resource groups, wherein each of the at least two frequency domain resource groups includes a plurality of contiguous frequency domain units, and frequency domain resources in the at least two frequency domain resource groups are frequency domain resources for SL PRS transmission.

In some embodiments, the plurality of frequency domain units are part of frequency domain units in a second SL BWP, wherein the second SL BWP is a BWP for SL communication.

In some embodiments, a frequency domain resource of a first PSCCH that schedules a transmission resource or a reserved resource of an SL PRS is located in an overlapped frequency domain unit in the plurality of frequency domain units, wherein the overlapped frequency domain unit is a frequency domain unit overlapping with frequency domain resources of an SL communication resource pool.

In some embodiments, a frequency resource assignment of the first PSCCH is all subchannels in which a transmission bandwidth of the SL PRS is overlapped with a transmission bandwidth of the SL communication resource pool.

In some embodiments, the configuration signaling indicates that the different types of time domain units are determined in a first logical time domain unit set based on a bitmap;
wherein the first logical time domain unit set is acquired by excluding time domain units unavailable for SL transmission within one time domain period.

In some embodiments, the configuration signaling indicates that:
the first-type time domain units are determined in synchronization time domain units within a time domain period based on a first bitmap;
the second-type time domain units are determined in reserved time domain units within the time domain period based on a second bitmap; and
the third-type time domain units are determined in a second logical time domain unit set based on a third bitmap;
wherein the second logical time domain unit set is acquired by excluding the synchronization time domain units, the reserved time domain units, and the time domain units unavailable for SL transmission within one time domain period.

In some embodiments, the configuration signaling indicates that:
the first-type time domain units include all the synchronization time domain units;
the second-type time domain units are determined in reserved time domain units within a time domain period based on a second bitmap; and
the third-type time domain units are determined in a second logical time domain unit set based on a third bitmap;
wherein the second logical time domain unit set is acquired by excluding the synchronization time domain units, the reserved time domain units, and the time domain units unavailable for SL transmission within one time domain period.

In some embodiments, the SL PRS resource pool is overlapped with at most with one SL communication resource pool in time-frequency domain resources.

In some embodiments, the configuration signaling indicates that SL PRS resource pool is the same as the SL communication resource pool.

In some embodiments, frequency domain resources for SL PRS transmission in the SL PRS resource pool include: frequency domain units for SL communication and frequency domain units not for SL communication in the SL communication resource pool.

In some embodiments, a frequency domain resource of a second PSCCH that schedules a transmission resource or a reserved resource of an SL PRS is located in a 1st frequency domain unit for SL PRS transmission.

In some embodiments, a frequency resource assignment of the second PSCCH is all subchannels in which a transmission bandwidth of the SL PRS is overlapped with a transmission bandwidth of the SL communication resource pool.

In summary, in the apparatus according to the embodiments of the present disclosure, the frequency domain resources and/or the time domain resources of the SL PRS resource pool are flexibly configured by the configuration signaling, which supports configuring different frequency domain resources and/or time domain resources for SL PRS and SL communication, prevents mutual influences between signals and channels for SL PRS and SL communication, and improves effectiveness of SL communication resources; and also supports configuring same or overlapped frequency domain resources and/or time domain resources for SL PRS and SL communication, and improves utilization of SL communication resources.

It should be noted that, when the apparatus according to the above embodiments implements the functions thereof, the division of the functional modules is merely exemplary. In practice, the functions may be designated to different function modules for implementation depending on actual requirements. That is, the device may be divided into different functional modules in terms of internal structure, to implement all or part of the functions described above.

With respect to the apparatus in the foregoing embodiments, a specific manner in which each module performs operations has been described in detail in the embodiments related to the method, and details are not described herein.

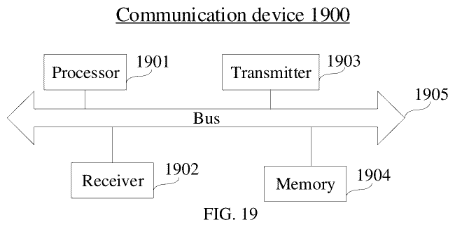

FIG. 19 is a schematic structural diagram of a communication device for configuring resources (a terminal or a network device) according to some embodiments of the present disclosure. The communication device 1900 includes: a processor 1901, a receiver 1902, a transmitter 1903, a memory 1904, and a bus 1905.

The processor 1901 includes one or more processing cores. The processor 1901 runs various functional applications and performs information processing by running software programs and modules.

The receiver 1902 and the transmitter 1903 may be implemented as a communication assembly. The communication assembly may be a communication chip.

The memory 1904 is connected to the processor 1901 over the bus 1905. The memory 1904 may be configured to store at least one instruction. The processor 1901, when executing the at least one instruction, is caused to perform the processes in the above method embodiments.

In addition, the memory 1904 may be implemented by any type of volatile or non-volatile storage device or a combination thereof. The volatile or non-volatile storage device includes, but is not limited to, a magnetic disk or an optical disc, an electrically erasable programmable read-only memory (EEPROM), an erasable programmable read-only memory (EPROM), a static random-access memory (SRAM), a read-only memory (ROM), a magnetic memory, a flash memory, and a programmable read-only memory (PROM).

Some embodiments further provide a non-transitory computer-readable storage medium. The non-transitory computer-readable storage medium stores one or more executable programs. The one or more executable programs, when loaded and run by a processor of a communication device, cause the communication device to perform the method for configuring resources as described in the above aspect.

Some embodiments further provide a chip. The chip includes at least one programmable logic circuit or one or more programs. A communication device equipped with the chip is configured to perform the method for configuring resources as described in the above aspect.

Some embodiments further provide a computer program product. The computer program product includes one or more computer programs stored in a non-transitory computer-readable storage medium. The one or more computer programs, when read from the non-transitory computer-readable storage medium and run by a processor of a communication device, cause the communication device to perform the method for configuring resources as described in the above aspect.

Those skilled in the art should be aware that, in the foregoing one or more examples, functions described in the embodiments of the present disclosure may be implemented by hardware, software, firmware, or any combination thereof. When the functions are implemented by software, the functions may be stored in a non-transitory computer-readable medium or transmitted as one or more program instructions or codes in the non-transitory computer-readable medium. The non-transitory computer-readable medium includes a computer storage medium and a communication medium. The communication medium includes any medium that enables a computer program to be transmitted from one place to another place. The storage medium may be any available medium accessible to a general-purpose or special-purpose computer.

The above are merely embodiments of the present disclosure, and are not intended to limit the present disclosure. Any modification, equivalent replacement, improvement, or the like made within the principles of the present disclosure shall fall within the protection scope of the present disclosure.

1. A method for configuring resources, comprising:
receiving configuration signaling, wherein the configuration signaling comprises at least one of a configuration of frequency domain resources or a configuration of time domain resources of a sidelink positioning reference signal (SL PRS) resource pool.

2. The method according to claim 1, wherein frequency domain resources for SL PRS transmission in each time domain unit in the SL PRS resource pool are the same.

3. The method according to claim 2, wherein the frequency domain resources for SL PRS transmission in each time domain unit are determined in a first frequency domain configuration mode, or determined in a second frequency domain configuration mode, or determined in a third frequency domain configuration mode.

4. The method according to claim 3, wherein the second frequency domain configuration mode is a configuration mode based on one frequency domain resource group, wherein the frequency domain resource group comprises a plurality of contiguous frequency domain units, and frequency domain resources in the frequency domain resource group are frequency domain resources for SL PRS transmission.

5. The method according to claim 4, wherein the plurality of frequency domain units are part of frequency domain units in a second sidelink bandwidth part (SL BWP), wherein the second SL BWP is a BWP for SL communication.

6. The method according to claim 1, wherein different types of time domain units are determined in a first logical time domain unit set based on a bitmap;
wherein the first logical time domain unit set is acquired by excluding time domain units unavailable for SL transmission within one time domain period.

7. The method according to claim 1, wherein the SL PRS resource pool is the same as an SL communication resource pool.

8. The method according to claim 1, wherein transmission bandwidth of an SL PRS is all PRBs comprised in the SL PRS resource pool.

9. The method according to claim 1, wherein a start point of frequency domain resources for SL PRS transmission is a start point of one subchannel of SL communication resource pool, and an end point of the frequency domain resources for SL PRS transmission is an end point of one subchannel of the SL communication resource pool.

10. A terminal, comprising:
a processor;
a transceiver connected to the processor; and
a memory configured to store one or more executable programs;
wherein the processor, when loading and running the one or more executable programs, is caused to perform:
receiving configuration signaling, wherein the configuration signaling comprises at least one of a configuration of frequency domain resources or a configuration of time domain resources of a sidelink positioning reference signal (SL PRS) resource pool.

11. The terminal according to claim 10, wherein frequency domain resources for SL PRS transmission in each time domain unit in the SL PRS resource pool are the same.

12. A network device, comprising:
a processor;
a transceiver connected to the processor; and
a memory configured to store one or more executable programs;
wherein the processor, when loading and running the one or more executable programs, is caused to perform:
transmitting configuration signaling, wherein the configuration signaling comprises at least one of a configuration of frequency domain resources or a configuration of time domain resources of a sidelink positioning reference signal (SL PRS) resource pool.

13. The network device according to claim 12, wherein the configuration signaling indicates that frequency domain resources for SL PRS transmission in each time domain unit in the SL PRS resource pool are the same.

14. The network device according to claim 13, wherein the configuration signaling comprises a first frequency domain configuration mode, or a second frequency domain configuration mode, or a third frequency domain configuration mode that determines the frequency domain resources for SL PRS transmission in each time domain unit.

15. The network device according to claim 14, wherein the second frequency domain configuration mode is a configuration mode based on one frequency domain resource group, wherein the frequency domain resource group comprises a plurality of contiguous frequency domain units, and frequency domain resources in the frequency domain resource group are frequency domain resources for SL PRS transmission.

16. The network device according to claim 15, wherein the plurality of frequency domain units are part of frequency domain units in a second sidelink bandwidth part (SL BWP), wherein the second SL BWP is a BWP for SL communication.

17. The network device according to claim 12, wherein the configuration signaling indicates that different types of time domain units are determined in a first logical time domain unit set based on a bitmap;
wherein the first logical time domain unit set is acquired by excluding time domain units unavailable for SL transmission within one time domain period.

18. The network device according to claim 12, wherein the configuration signaling indicates that the SL PRS resource pool is the same as an SL communication resource pool.

19. The network device according to claim 12, wherein transmission bandwidth of an SL PRS is all PRBs comprised in the SL PRS resource pool.

20. The network device according to claim 12, wherein a start point of frequency domain resources for SL PRS transmission is a start point of one subchannel of SL communication resource pool, and an end point of the frequency domain resources for SL PRS transmission is an end point of one subchannel of the SL communication resource pool.
